(19) United States
(12) Patent Application Publication
(10) Pub. No.: US 2014/0304707 A1
(43) Pub. Date: Oct. 9, 2014

(54) METHOD AND APPARATUS FOR CREATING PARAMETER SET

(71) Applicant: SIEMENS AKTIENGESELLSCHAFT, München (DE)

(72) Inventors: Gero Bäse, Munich (DE); Norbert Oertel, Landshut (DE)

(21) Appl. No.: 14/360,496

(22) PCT Filed: Oct. 23, 2012
(86) PCT No.: PCT/EP2012/070943

§ 371 Date: May 23, 2014

(30) Foreign Application Priority Data
Nov. 23, 2011 (DE) 102011119177.5

(51) Int. Cl. G06F 9/48

(52) U.S. Cl. CPC G06F 9/4843
USPC 718/100

(57) ABSTRACT

A first set of parameters for describing additional items of information that are needed to process a data block of a data stream at a processing time are compiled using a processing unit. The method can be used in distribution services where a user wishes to access the data block at different times.

### CROSS REFERENCE TO RELATED APPLICATIONS

This application is the U.S. national stage of International Application No. PCT/EP2012/070943, filed, Oct. 23, 2012 and claims the benefit thereof. The International Application claims the benefit of German Application No. 102011119177.5 filed on Nov. 23, 2011, both applications are incorporated by reference herein in their entirety.

### BACKGROUND

Described below are a method and an apparatus for creating a first parameter set.

In recent years, there has been a considerable increase in a number of coding methods, such as image, voice or video compression methods, and transmission standards. Therefore, integration of these methods, particularly taking account of an extremely wide variety of hardware requirements for terminals, involves a considerable increase in complexity for the integration.

In addition, end customers desire ease of use, particularly even when they would like to use almost arbitrary methods to access contents coded using the coding methods.

### SUMMARY

A method and an apparatus described below ensure both simple integration of an extremely wide variety of coding methods and ease of use of coded contents for a user.

The method for creating a first parameter set for describing supplementary information that is needed by a processing unit for processing a data block of a data stream at a processing time, includes:
a) Ascertainment of in each case at least one parameter set for one or more coding methods, wherein the respective parameter set has at least one parameter of a respective parameter type and the respective parameter set represents the respective supplementary information that the processing unit needs for processing the data block,
b) Comparison of the parameter sets of the plurality of coding methods such that the comparison result ascertained is those parameter sets that include at least one identical parameter type,
c) Creation of the first parameter set such that the first parameter set has a parameter of the at least one identical parameter type from the ascertained parameter sets.

The method allows entry into a data stream at a particular time using the first parameter set. Thus, in the case of a streaming application, it is possible to transmit the first parameter set to a terminal for entry into a live stream, the first parameter set then being able to be used by the terminal to start processing the data in the live stream.

Particularly the description of the first parameter set for a plurality of coding methods and/or for a plurality of processing times for a coding method allows efficient and inexpensive realization, since an identical structure for the first parameter set is made possible over a plurality of coding methods. This also reduces a level of complexity in a transmitter and/or receiver, since the latter is able to resort to a standardized parameter set for a plurality of coding methods instead of dedicated parameter sets for each coding method.

In this connection, coding methods are understood to mean not only compression methods such as for video, image, voice, music and files but also methods for presenting and/or storing information, such as Word, Excel or PowerPoint from Microsoft. In this case, the data stream may be in compressed form, in binary form or in text form, such as an HTML or XML document (HTML—HyperText Markup Language, XML—Extensible Markup Language). Within the context of this description, parameter type is understood to be a specific meaning of a parameter that is standard across the boundaries of coding methods, such as an image size, a coding type, a length of a motion vector, a time statement or a length statement for a field in bits or bytes. Hence, a parameter has a specific meaning, expressed by the parameter type. In addition, the parameter type may also define a specific presentation of the value of a parameter, such as a date in the form of HH:MM:SS (HH—hours, MM—minutes and SS—seconds). A specific value for a parameter is then stored in the parameter set for the respective parameter.

In an extension of the method, the first parameter set is designed such that it also has a further parameter of the at least one of the parameter types that is not contained in all the ascertained parameter sets, and signaling of supplementary information prompts the further parameter to be preassigned a predefined value that indicates that the further parameter can be ignored by the processing unit during an evaluation. This further reduces a level of complexity, since a number of first parameter sets is reduced. In addition, this reduces a level of complexity for implementation.

In an advantageous embodiment, in addition, or as an alternative to the preceding extension, the first parameter set can be formed such that it has parameters of all the identical parameter types from the ascertained parameter sets. This restriction combines those parameter sets that have identical parameter types to form the first parameter set. This avoids inconsistencies for evaluation of the first parameter set.

An apparatus for creating a first parameter set for describing supplementary information that is needed by a processing unit for processing a data block of a data stream at a processing time, has the following units:
a) First unit for ascertaining in each case at least one parameter set for one or more coding methods, wherein the respective parameter set has at least one parameter of a respective parameter type and the respective parameter set represents the respective supplementary information that the processing unit needs for processing the data block,
b) Second unit for comparing the parameter sets of the plurality of coding methods such that the comparison result ascertained is those parameter sets that include at least one identical parameter type, and
c) For creating the first parameter set such that the first parameter set has a parameter of the at least one identical parameter type from the ascertained parameter sets.

As a result, the method is implementable and executable. The advantages and definitions are similar to those for the method.

In a development of the apparatus, the second unit is also designed to implement and execute extensions of the method. The advantages are similar to those for the method.

Finally, the first parameter set describes supplementary information that is needed by a processing unit for processing a data block of a data stream at a processing time. The first parameter set is produced particularly on the basis of the method or is produced by the apparatus. This allows the first parameter set to be used in a transmitter and/or receiver, where it achieves a reduction in the implementation complexity.

The method can be used in standards for compression, for transmission, such as RTP, and/or for storing data streams. The first parameter set can be transmitted or stored in headers of transmission protocols together with the data block of the data stream or in a transmission packet that is separate from a data block. The first parameter set in a transmission packet can be signaled by MIME (MIME—Multipurpose Internet Mail Extensions), for example.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of a design and procedure for creating a first parameter set,

FIG. 2 is a block diagram of application of the first parameter set for data transmission from a transmitter to a receiver.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

Elements having the same function and mode of action are provided with the same reference symbols in the figures.

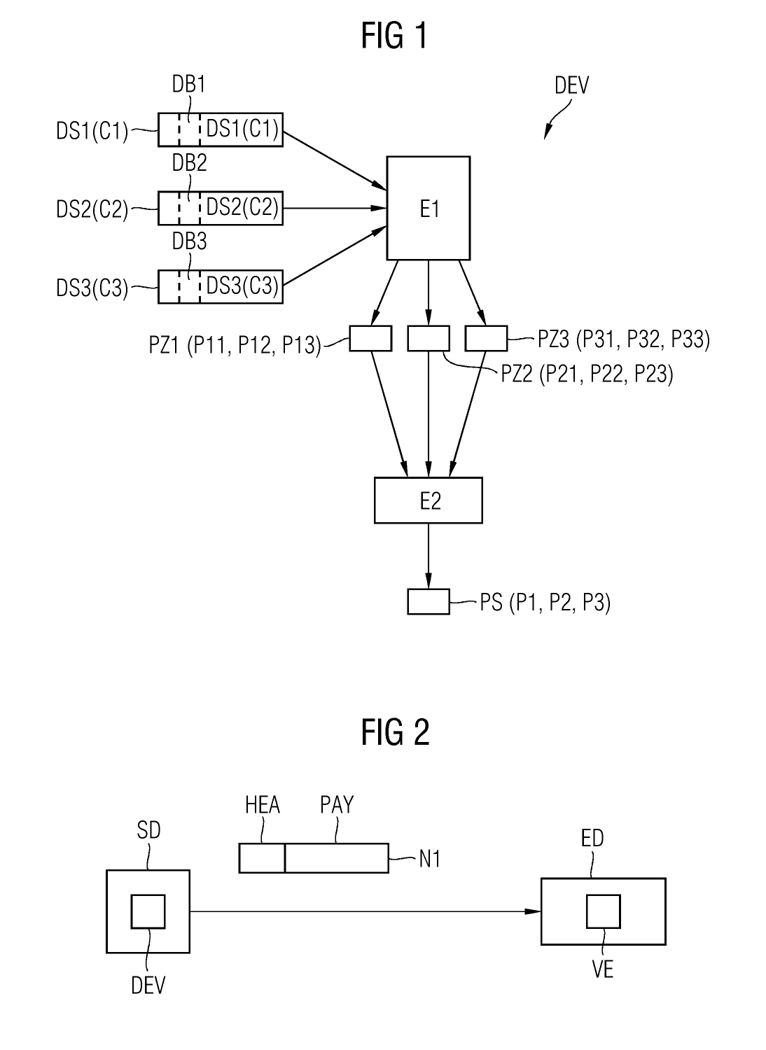

FIG. 1 shows an exemplary embodiment. In this case, three data streams DS1, DS2, DS3 are depicted that have been produced by three different coding methods C1, C2, C3. The coding methods are:
C1: H.261
C2: H.263
C3: H.264

The coding methods H.261, H.263 and H.264 are video coding methods, standardized by ITU (ITU—International Telecommunications Union). A more detailed explanation of these standards is dispensed with, since they are sufficiently well known to a person skilled in the art in the field of multimedia coding.

At a particular time, also called processing time VZP, in the respective data stream, not shown in FIG. 1, decoding of a data block DB1, DB2, DB3 of the respective data stream is meant to be made possible. To this end, a first unit E1 determines for the respective data block DB1, taking account of the respective coding method C1, parameters P11, P12, P13 that are additionally needed for decoding besides the respective data block C1. The type of the respective parameter is called parameter type PT1, PT2, PT3.

For the coding method C1, the following parameters have been ascertained as parameter set PZ1:

| Parameter | Parameter type |
|---|---|
| P11 PT1: | Macroblock number |
| P12 PT2: | Slice number |
| P13 PT3: | Image type |

For the coding method C2, the following parameters have been ascertained as parameter set PZ2:

| Parameter | Parameter type |
|---|---|
| P21 PT1: | Macroblock number |
| P22 PT4: | Number of packets to be received |
| P23 PT3: | Image type |
| P24 PT2: | Slice number |

For the coding method C3, the following parameters have been ascertained as parameter set PZ3:

| Parameter | Parameter type |
|---|---|
| P31 PT1: | Macroblock number |
| P32 PT2: | Slice number |
| P33 PT3: | Image type |

The three parameter sets are transferred to a second unit E2 for analysis. The second unit compares the three parameter sets to determine whether they have identical parameter types. The analysis reveals which parameter types are represented in which parameter set:

| Parameter | Parameter set |
|---|---|
| PT1: | PZ1, PZ2, PZ3 |
| PT2: | PZ1, PZ2, PZ3 |
| PT3: | PZ1, PZ2, PZ3 |
| PT4: | PZ2 |

From this, it is evident that, although all the parameter sets have the parameter types PT1, PT2 and PT3, the further parameter type PT4 is also necessary for describing the second parameter set completely. It should also be mentioned that an order of the parameters and hence also an order of parameter types is insignificant in this example.

There are subsequently several variants for forming the first parameter set PS:

### Variant 1:

The first parameter set P1 merely describes the parameter sets PZ1 and PZ3. In that case, the first parameter set is formed as follows:

| Parameter | Parameter type |
|---|---|
| P1 PT1: | Macroblock number |
| P2 PT2: | Slice number |
| P3 PT3: | Image type |

Hence, it is possible to indicate the first parameter set in order to specify which parameter types are explicitly needed as supplementary information so that the processing, for example decoding by a decoder, of the data packet can be performed. In this variant, this description of the parameter set can also be carried out independently of the specific coding method, since the identical parameter types can be used for the coding methods 1 and 3. It goes without saying that the values represented by the respective parameters of the respective parameter type are dependent on the respectively chosen coding method.

### Variant 2:

In this case, the first parameter set PS is chosen such that the parameters needed can be signaled to all three coding methods. The first parameter set is then formed as follows:

| Parameter | Parameter type |
|---|---|
| P1 PT1: | Macroblock number |
| P2 PT2: | Slice number |
| P3 PT3: | Image type |
| P4 PT4: | Number of packets to be received |

The parameter type PT4 does not occur in the parameter sets PZ1 and PZ3, however. When the first parameter set is used for signaling the parameter sets PZ1 and PZ3, a value for the parameter representing the parameter type PT4 is set to a predefined value that indicates that the parameter cannot be used. Alternatively, however, the parameter associated with the parameter type PT4 can assume any value and is ignored depending on the coding method.

The values of the parameters in the first parameter set can be transmitted from a transmitter SD to a receiver ED in a message N1. The message has the values in a message header HEA and the data packet in the payload area PAY. In particular, the message header is transmitted to the receiver ahead of the payload area in time.

The receiver ED receives the message N1, and extracts and analyzes the message header and possibly also the payload area. Using a processing unit VE, the receiver is able to operate on the received values of the first parameter set to perform the processing of the data block DB1.

During the transmission, the values of the first parameter set can be provided in an RTP header extension, for example from an ONVIF standard (RTP—Real Time Transport Protocol; ONVIF—Open Network Video Interface Forum).

For a data stream, the chosen parameter types of the first parameter set are dependent on the chosen processing time, inter alia. In the case of H.264, for example, different parameter types are necessary at the start of an IDR image (IDR—instantaneous decoder refresh) than at the start of a P image (P—predicted image). When the first parameter set is generated, it makes sense to determine the parameter types not for every bit position within the data stream but rather for typical entry points, which could be prescribed by a respective coding standard, such as in the case of a scene change for an image sequence.

In the present exemplary embodiment, the respective parameter set PZ1, PZ2, PZ3 is ascertained from the respective data stream DS1, DS2 and DS3. Generally, mere analysis of the respective coding method C1, C2, C3 allows ascertainment of which supplementary information—that is to say parameters of particular parameter types—is needed for processing the subsequently produced data block in a particular state of the coding method. In addition, it may also be the case that for a particular state of the coding method there are several options for supplementary information that is needed. In this case, it is possible to create a plurality of parameter sets that are then taken into account when creating the first parameter set—or a plurality of first parameter sets are generated that can then be used on a situational basis.

In addition, buffer instructions can be used as a parameter type in the case of the coding method H.264 at a processing time for an IDR image that needs to be decoded.

When the method is applied to coding according to AAC (AAC—Advanced Audio Coding), the parameter type specified could be a number of audio samples that are needed before processing starts, for example.

The first unit, the second unit and the processing unit can be realized and implemented in software, hardware or in a combination of software and hardware. In this case, the respective units can read the respective operations of the method from a memory module and execute them using a computation unit that is connected to the memory module. In addition, the units may also have input and output interfaces for the interchange of data and information. The method can be used inter alia in the field of multimedia servers, an extremely wide variety of terminals, e.g. in a hospital with portable data retrieval appliances and fixed high-performance computers that provide data streams stored on the multimedia servers.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-6. (canceled)

7. A method for creating a first parameter set for describing supplementary information that is needed by a processing unit for processing a data block of a data stream at a processing time, comprising:
ascertaining at least one parameter set for each of at least one coding method, where a respective parameter set has at least one parameter of a respective parameter type and the respective parameter set represents respective supplementary information that the processing unit needs for processing the data block;
comparing available parameter sets of coding methods to obtain a comparison result indicating ascertained parameter sets having at least one identical parameter type; and
generating the first parameter set having a first parameter of the at least one identical parameter type from the ascertained parameter sets.

8. The method as claimed in claim 7,
wherein the respective parameter type is one of several parameter types,
wherein said generating includes in the first parameter set a second parameter of a different parameter type that is not included in all of the ascertained parameter sets, and
wherein said method further comprises:
signaling the supplementary information; and
preassigning, in response to said signaling, a predefined value to the second parameter, indicating that the second parameter can be ignored by the processing unit during an evaluation.

9. The method as claimed in claim 8, wherein said generating includes in the first parameter set parameters of all the identical parameter types from the ascertained parameter sets.

10. An apparatus for creating a first parameter set for describing supplementary information that is needed by a processing unit for processing a data block of a data stream at a processing time, comprising:
a first unit ascertaining at least one parameter set for a plurality of coding methods, where a respective parameter set has at least one parameter of a respective parameter type and the respective parameter set represents the respective supplementary information that the processing unit needs for processing the data block; and
a second unit comparing parameter sets of coding methods to obtain a comparison result indicating ascertained parameter sets having at least one identical parameter type and generating the first parameter having a first parameter of the at least one identical parameter type from the ascertained parameter sets.

11. The apparatus as claimed in claim 10,
wherein the respective parameter type is one of several parameter types, and
wherein said second unit
includes in the first parameter set a second parameter of a different parameter type that is not included in all of the ascertained parameter sets,
signals the supplementary information, and
preassigns, in response to the signaling, a predefined value to the second parameter, indicating that the second parameter can be ignored by the processing unit during an evaluation.

12. The apparatus as claimed in claim 10, wherein said second unit includes in the first parameter set parameters of all the identical parameter types from the ascertained parameter sets.

13. A non-transitory computer readable medium embodying a data structure operated on by a processing unit, comprising:
a first parameter set describing supplementary information needed by the processing unit for processing a data block of a data stream at a processing time, the first parameter set having a first parameter of at least one identical parameter type included in all of ascertained parameter sets, each of the ascertained parameter sets corresponding to at least one coding method, where a respective parameter set has at least one parameter of a respective parameter type and the respective parameter set represents respective supplementary information that the processing unit needs for processing the data block.

14. A non-transitory computer readable medium embodying instructions that when executed by a processor cause the processor to execute a method for creating a first parameter set for describing supplementary information that is needed by a processing unit for processing a data block of a data stream at a processing time, said method comprising:
ascertaining at least one parameter set for each of at least one coding method, where a respective parameter set has at least one parameter of a respective parameter type and the respective parameter set represents respective supplementary information that the processing unit needs for processing the data block;
comparing available parameter sets of coding methods to obtain a comparison result indicating ascertained parameter sets having at least one identical parameter type; and
generating the first parameter set having a first parameter of the at least one identical parameter type from the ascertained parameter sets.
